(19) United States
(12) Patent Application Publication
(10) Pub. No.: US 2010/0129750 A1
(43) Pub. Date: May 27, 2010

(54) DISPERSIBLE NANOPARTICLES

(75) Inventors: Christoph Briehn, Zeilarn (DE); Martina Baumann, Sauerlach (DE); Carolin Kinzler, Munich (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/597,865

(22) PCT Filed: Apr. 22, 2008
(86) PCT No.: PCT/EP08/54833

§ 371 Date: Oct. 27, 2009

(30) Foreign Application Priority Data
May 4, 2007 (DE) 10 2007 021 002.9

(51) Int. Cl. G03G 9/08; C04B 41/49; C04B 16/00; C09K 13/00; C09K 3/00; G03G 9/097; B01J 20/22

(52) U.S. Cl. 430/108.24; 106/287.14; 106/481; 252/79.1; 252/182.3; 430/108.3; 502/401

(57) ABSTRACT

Pulverulent particles (P) have surface groups of the general formula (1): —O₁₊ₙ—SiR¹₂₋ₙ—B, the average diameter of the particles (P) following dispersion in water with a pH range of 1 to 12 being less than or equal to 200 nm, and being determined as the average hydrodynamic equivalent diameter in the form of the Z-average by means of photon correlation spectroscopy, R¹ being an optionally substituted aliphatic or aromatic hydrocarbon radical having 1-12 carbon atoms, B being an optionally substituted aliphatic or aromatic hydrocarbon radical containing at least one organic acid function and/or salt thereof, and n being 0, 1 or 2.

The invention relates to pulverulent particles, to their preparation and to dispersion thereof in aqueous and organic media.

Composite materials comprising particles—more particularly nanoparticles—are prior art. Corresponding coatings comprising composite materials are described for example in EP 1 249 470, WO 03/16370, US 20030194550 or US 20030162015. The particles in these systems lead to an improvement in the properties of the corresponding coatings, more particularly with regard to their scratch resistance and also, possibly, their chemical resistance as well.

A problem which frequently occurs when the particles—which in general are inorganic—are employed in organic matrix systems is a usually insufficient compatibility between particle and matrix. A possible result of this is that the particles cannot be adequately dispersed in the matrix. Moreover, even well-dispersed particles may settle in the course of prolonged standing times or storage times, with the formation, possibly, of relatively large aggregates and/or agglomerates, which are difficult if not impossible to separate into the original particles, even by introduction of energy. The processing of inhomogeneous systems of this kind is extremely difficult in any case, and often in fact impossible.

Dispersions of nanoparticles, more particularly aqueous dispersions, find use, for example, as free-flow assistants, for charge control in toners and developers, in powder coating materials, as an abrasive particulate in polishing operations, as a rheological additive for water-based adhesives and sealants, and for modifying the surface properties of various substrates such as, for example, textile fibers or paper.

The stability of aqueous dispersions of nanoparticles is critically determined by the amount of the surface charge density of the dispersed particle. Increasing surface charge density is accompanied by a rise in the stability of the dispersion with respect to gelling and sedimentation.

The sign, the amount, and the density of the surface charge of particulate metal oxides are critically determined by the chemical structure of the particle surface. In the case of unmodified metal oxides such as silicon dioxide, aluminum oxide or titanium dioxide, the hydroxyl groups present on the surface are the charge-determining groups. On the basis of the acid-base properties of these hydroxyl groups, the surface charge of the particles is dependent on the pH of the surrounding medium: A low pH leads, through protonation of the hydroxyl group, to a positive surface charge; a high pH leads, through deprotonation of the hydroxyl group, to a negative surface charge. As a result of the pH dependence, the surface charges are heavily dependent on the ambient conditions. This dependence of the surface charge on the pH may have an adverse influence, for example, on the stability of aqueous dispersions of said particulate metal oxides. For this reason, there is a need for dispersions comprising nanoparticles whose surface charge ensures stability of the dispersion over a wide pH range.

It is therefore advantageous to use particles (and corresponding dispersions) which on their surface possess organic groups which lead to better compatibility of the particles with the surrounding matrix or result in electrostatic and/or steric stabilization of the dispersion and hence suppress unwanted agglomeration and aggregation of the particles.

In accordance with the prior art, surface-modified particles are prepared by subjecting nanoparticles which possess free silanol (SiOH) functions or metal hydroxide functions to reaction with alkoxysilanes, or their hydrolysis and condensation products, which comprise unreactive groups, such as alkyl or aryl radicals, for example, or reactive organic functions, such as vinyl, (meth)acryloyl, carbinol, amine, etc., for example.

A disadvantage is the stability—which despite the modified surface is inadequate—of the modified nanoparticles used in the prior art for the preparation of composite materials or dispersions. This inadequate stability on the part of the particles and/or the corresponding dispersions is manifested first in the processing of the particles, particularly in the course of concentration of the particle dispersions and/or solvent exchange, and second during the storage of the particle dispersions. Signs of inadequate stability of the particles are an increase in viscosity—frequently progressing to the point of gelling—or the sedimentation of the particles. Moreover, on account of the high agglomeration/aggregation tendency, the nanoparticles described cannot be isolated as redispersible solids. On isolation, by spray drying, for example, the particles which can be prepared according to the prior art are obtained as particle agglomerates or particle aggregates, which, in particular after storage at elevated temperature, cannot be redispersed with attainment of the original primary particle size, even with introduction of energy, as for example by means of a bead mill or by ultrasound treatment. Such redispersion, however, would be particularly desirable with regard to storage, transport, and—in particular—the processing of the powders, in extrusion operations, for example.

DE 102 97 612 T5 describes water-redispersible powders (by redispersibility is meant here that the ratio of the average particle size of the redispersible particles to the average particle size of the sol particles used for the preparation is between 1 and 2) which are obtained by treating an aqueous dispersion of an inorganic sol with an alkylalkoxysilane or amino-alkylalkoxysilane, and the subsequent drying of the dispersion. Redispersion of the aminoalkylsilane-modified particles to the size of the inorganic sol particles originally employed is accomplished by protonation of the basic amino groups and thus by electrostatic repulsion of the resultant ammonium-functional particles.

A disadvantage of the particles claimed in DE 102 97 612 T5 is that the amino-modified particles are incompatible with a large number of matrix systems. As a consequence, in the composite material, instead of a desired homogeneous distribution of isolated nanoparticles, large particle agglomerates are observed, which frequently result in a deterioration in the mechanical properties. A disadvantage of the particles described, moreover, is that their dispersion in water necessitates the addition of strong acids.

WO 2004/000916 describes the preparation of aqueous dispersions of nanoparticles by reaction of metal oxides with polymeric anionic dispersants. A disadvantage of this preparation process is the use of dispersants which, as a result of inadequate reactivity, are not capable of permanent attachment to the particles. Accordingly the surface charge is dependent on the position of the adsorption-desorption equilibrium. In an aqueous medium, partial or complete desorption of the dispersant is likely, leading to dispersions whose storage stability goes down over the course of time.

It is an object of the invention to improve on the prior art, and more particularly to develop particles and dispersions thereof that overcome the disadvantages of the prior art.

The invention provides pulverulent particles (P) which on the surface have groups of the general formula [1],

—O₁₊ₙ—SiR¹₂₋ₙ—B [1]

where the average diameter of the particles (P) following dispersion in water with a pH range of 1 to 12 is less than or equal to 200 nm and is determined as the average hydrodynamic equivalent diameter in the form of the Z-average by photon correlation spectroscopy,

and where
R¹ is an optionally substituted aliphatic or aromatic hydrocarbon radical having 1-12 carbon atoms,
B is an optionally substituted aliphatic or aromatic hydrocarbon radical comprising at least one organic acid function or salts thereof, and
n adopts the values 0, 1 or 2.

B is preferably an optionally substituted hydrocarbon radical comprising at least one carboxylic acid [—C(O)OH], phosphonic acid [—P(O)(OH)(OR²), —O—P(O)(R²)(OR²)] or sulfonic acid [—S(O)₂(OH)] function or salts thereof, where R² is an optionally substituted aliphatic or aromatic hydrocarbon radical. n preferably adopts the values 1 and 2. R¹ is preferably a methyl, ethyl or phenyl group.

The average diameter of the particles (P)—measured as the average hydrodynamic equivalent diameter in the form of the Z-average by photon correlation spectroscopy—in dispersion in a liquid medium is preferably not more than 200 nm, more preferably not more than 100 nm, very preferably not more than 50 nm. The particles (P) may take the form of aggregates (definition according to DIN 53206) or agglomerates (definition according to DIN 53206) of correspondingly smaller primary particles.

In one embodiment of the invention the particles (P) in addition to the functions of the general formula [1] also contain at least one organofunctional group (F) with which, for example, covalent attachment of the particles (P) to a correspondingly functionalized (polymeric) matrix is possible. Examples of organofunctional groups (F) are amino groups, epoxide groups, acrylato groups, methacrylato groups, and hydroxyl groups.

The pulverulent particles (P) preferably have a residual moisture content of less than 10% by weight, preferably less than 5% by weight, and more preferably less than 2% by weight.

The invention further provides a process for preparing the pulverulent particles (P) by a two-stage process, where
(a) in a first process stage, particle (P1) is reacted with at least one silane (S) of the general formula [2] or [3],

X₁₊ₙSiR¹₂₋ₙ—B [2],

X₁₊ₙSiR¹₂₋ₙ—C [3],
and/or the hydrolysis and condensation products derived therefrom, or with a mixture consisting of the silane (S) and the hydrolysis and condensation products derived therefrom, the group C of the general formula [3] being converted, in the course of the preparation of the particles (P), into the group B, and
(b) in a second process stage, the particles (P) are isolated as powder, the average diameter of the particles (P) after dispersion in water in the pH range from 1 to 12, with a maximum size of 200 nm, corresponding to 0.5 to 20 times the average diameter of the particles before isolation as a powder, and the average diameter of the particles (P) being determined as the average hydrodynamic equivalent diameter in the form of the Z-average by photon correlation spectroscopy,

where
X is a halogen, a hydroxyl or alkoxy group, a carboxylate, an enolate or a siloxy group —O—Si≡,
C is a functional hydrocarbon radical which can be converted by hydrolysis into the group B, and
B, R¹, and n have the definitions stated for the general formula [1].

X is preferably chlorine, hydroxyl, methoxy or ethoxy. The radicals C are preferably hydrocarbon radicals which as functional groups contain carboxylic chlorides, carboxylic anhydrides, carboxylic esters, phosphonic chlorides, phosphonic anhydrides, phosphonic esters, sulfonic chlorides, sulfonic anhydrides or sulfonic esters.

The attachment of the silanes (S) to the particles (P1) is accomplished by substitution or condensation after hydrolysis has taken place, or else by equilibration. The procedure for the substitution, condensation or equilibration, and also the catalysts needed for these reactions, are familiar to the skilled person and are widely described in the literature.

Suitable silanes (S) are all silanes which are reactive toward the surface functions of the particle (P1), and possess a group B or C. Where a silane (S) comprising a group C is employed, the group C is converted, in the course of the preparation process, through hydrolysis, i.e., through reaction of the group C with water or a hydroxide ion, into a group B. Typically the conversion takes place after attachment of the silane or its hydrolysis and condensation products to the particle (P1). Examples of reactions which allow conversion of the group C into the group B are the hydrolysis of an acid chloride or an anhydride, and the saponification of an ester.

In one particularly preferred embodiment of the invention the silanes (S) used to modify the particles (P1) have a structure of the general formulae [4]-[8],

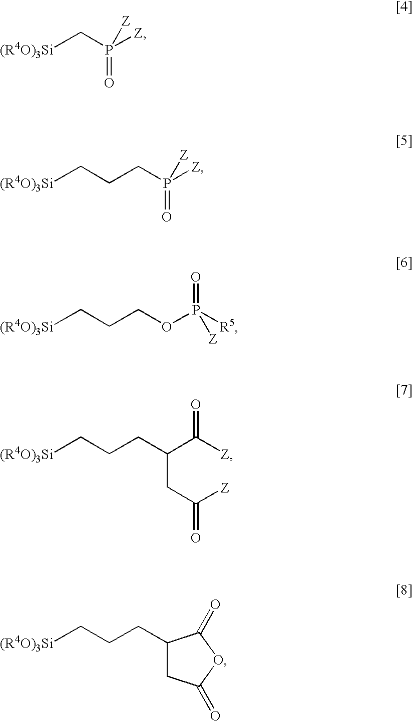

where
R⁴ is hydrogen or an optionally substituted aliphatic or aromatic hydrocarbon having 1-6 carbon atoms,
R⁵ is an optionally substituted aliphatic or aromatic hydrocarbon having 1-6 carbon atoms,
R⁶ is an optionally substituted aliphatic or aromatic hydrocarbon having 1-6 carbon atoms, and
Z is OH, OR⁶, a halogen atom or a radical OW, and
W is a metal cation or an ammonium ion.

R⁴ is preferably hydrogen, a methyl or ethyl radical. R⁵ and R⁶ are preferably methyl, ethyl or isopropyl, Z is preferably OH, OCH₃, OC₂H₅ or chlorine, and W is preferably a sodium, potassium or ammonium ion.

The silanes (S) or their hydrolysis or condensation products, that are used to modify the particles (P1) are used preferably in an amount of greater than 50 ppm, more preferably greater than 1% by weight, very preferably greater than 5% by weight, based in each case on the particles (P1).

In the preparation of the particles (P) from particles (P1) it is additionally possible, as well as the silanes (S) and their hydrolysis and condensation products, to use other silanes (S1), silazanes (S2) or siloxanes (S3). The silanes (S1), silazanes (S2) or siloxanes (S3) are preferably reactive toward the functions of the surface of the particle (P1). In this case the silanes (S1) and siloxanes (S3) possess either silanol groups or hydrolyzable silyl functions, the latter being preferred. The silanes (S1), silazanes (S2), and siloxanes (S3) may possess organic functions (F) which are reactive toward a binder, or alternatively it is possible to use silanes (S1), silazanes (S2), and siloxanes (S3) without organic functions. The silanes and siloxanes (S) may be used as a mixture with the silanes (S1), silazanes (S2) or siloxanes (S3). Additionally the particles can also be functionalized successively with the different silane types.

The weight fraction of the silanes (S1), silazanes

(S2), and siloxanes (S3) as a proportion of the total amount formed by the silanes (S) and (S1), silazanes (S2), and siloxanes (S3) is preferably less than 50% by weight, more preferably less than 15% by weight, and with particular preference not higher than 10% by weight. In another particularly preferred embodiment of the invention no compounds (S1), (S2), and (S3) at all are used.

Examples of such silanes (S1) are amino-functional silanes, such as aminopropyltrimethoxysilane, cyclo-hexylaminomethyltrimethoxysilane, phenylaminomethyltrimethoxysilane, silanes with unsaturated functions, such as vinyltrimethoxysilane, methacrylatopropyltrimethoxysilane, methacrylatomethyltrimethoxysilane, epoxy-functional silanes, such as glycidyloxypropyltrimethoxysilane, mercapto-functional silanes, such as mercaptopropyltrimethoxysilane, for example, silanes which possess a masked NCO group and on thermal treatment eliminate the protective group to release an NCO function, and silanes which on reaction with a particle (P1) release carbinol or amine functions.

Examples of preferred silanes (S1) which carry no organofunctional groups (F) are methyltrimethoxysilane, dimethyldimethoxysilane, trimethylmethoxysilane, phenyltrimethoxysilane, phenylmethyldimethoxysilane, and also the corresponding ethoxysilanes and chloro-silanes.

Particularly preferred silazanes (S2) and siloxanes (S3) used are hexamethyldisilazane, divinyltetramethyldisilazane or hexamethyldisiloxane, divinyltetramethyldisiloxane, or linear siloxanes which carry organofunctional groups laterally or terminally.

Examples of particles (P1) suitable for reasons of technical manageability include oxides with a covalent bond fraction in the metal-oxygen bond, preferably oxides of main group 3, such as boron, aluminum, gallium or indium oxides, of main group 4, such as silicon dioxide, more particularly pyrogenic silicon dioxide and colloidal silicon dioxide, germanium dioxide, tin oxide, tin dioxide, lead oxide, lead dioxide, or oxides of transition group 4, such as titanium oxide, zirconium oxide, and hafnium oxide. Further examples are nickel, cobalt, iron, manganese, chromium, cerium, and vanadium oxides and also metal oxides with a core/shell structure in which the core is composed, for example, of silicon dioxide and the shell of cerium oxide.

Suitability is possessed, furthermore, by metals with an oxidized surface, zeolites (a list of suitable zeolites is found in: Atlas of Zeolite Framework Types, 5th edition, Ch. Baerlocher, W. M. Meier, D. H. Olson, Amsterdam: Elsevier 2001), silicates, aluminates, aluminophosphates, titanates, and aluminum phyllo-silicates (e.g., bentonites, montmorillonites, smectites, hectorites).

The particles (P1) preferably possess an average diameter of ≦400 nm, more preferably ≦200 nm. The average diameter of the particles (P1) is determined as the average hydrodynamic equivalent diameter in the form of the Z-average by photon correlation spectroscopy or by means of transmission electron microscopy (TEM).

One preferred embodiment of the invention employs, as particles (P1), particles with surface functions which are selected from metal-OH, metal-O-metal, Si—OH, Si—O—Si, Si—O-metal, Si—Y, metal-Y, metal-OR³, and Si—OR³,

where
Y is a halogen atom and
R³ is an optionally substituted aliphatic or aromatic hydrocarbon having 1-10 carbon atoms.

Here Y is preferably a chlorine atom and R³ is preferably a methyl or ethyl group.

One preferred embodiment of the invention uses, as particles (P1), colloidal silicon oxides or metal oxides which generally take the form of a dispersion of the corresponding oxide particles of submicron size in an aqueous or organic solvent. Use may be made here, among others, of the oxides of the metals aluminum, titanium, zirconium, tantalum, tungsten, hafnium, cerium, and tin, or the corresponding mixed oxides. Silica sols are particularly preferred. The silica sols in general are preferably 1-50% strength by weight solutions, more preferably 20-40% strength by weight solutions. Typical solvents in this context, as well as water, are especially alcohols, more particularly alcohols having 1 to 6 carbon atoms, frequently isopropanol, but also other alcohols, usually of low molecular mass, such as methanol, ethanol, n-propanol, n-butanol, isobutanol, and t-butanol. Organosols are also available in polar aprotic solvents, such as methyl ethyl ketone or aromatic solvents, such as toluene, for example. The average particle size of the silicon dioxide particles (P1) is in general preferably 1-200 nm, more preferably 5-50 nm, very preferably 8-30 nm.

Examples of commercially available silica sols suitable for preparing the particles (P) are silica sols of the product series LUDOX® (Grace Davison), Snowtex® (Nissan Chemical), Klebosol® (Clariant), and Levasil® (H.C. Starck), silica sols in organic solvents such as IPA-ST (Nissan Chemical), for example, or those silica sols which can be prepared by the Stöber process.

Starting from the colloidal silicon oxides or metal oxides (P1), the preparation of the particles (P) may take place by a variety of processes. Preferably, however, it takes place by addition of the silanes (S) or their hydrolysis or condensation products—optionally in a solvent or solvent mixture and/or in mixtures with other silanes (S1), silazanes (S2), and siloxanes (S3)—to the particle (P1) or its solution in an aqueous or organic solvent. The reaction takes place in general at temperatures of preferably 0-200° C., more preferably at 20-80° C., and very preferably at 20-60° C. The reaction times typically are preferably 5 min to 48 h, more preferably 1 to 24 h. Optionally it is also possible for acidic, basic or heavy-metal-containing catalysts to be added. Such catalysts are used preferably in traces (<1000 ppm). With particular preference, however, the addition of separate catalysts is omitted.

Optionally the addition of water is preferred for the reaction of the particles (P1) with the silanes (S).

Since colloidal silicon oxides or metal oxides are present typically in aqueous or alcoholic dispersion, it may be advantageous to replace the solvent or solvents, during or after the preparation of the particles (P), by another solvent or by another solvent mixture. This can be done, for example, by distillative removal of the original solvent, with the new solvent or solvent mixture being able to be added in one step or else in two or more steps, before, during or else even after the distillation. Suitable solvents may be, for example, water, aromatic or aliphatic alcohols, with aliphatic alcohols, more particularly aliphatic alcohols having 1 to 6 carbon atoms (e.g., methanol, ethanol, n-propanol, isopropanol, n-butanol, isobutanol, t-butanol, the various regioisomers of pentanol and of hexanol) being preferred, esters (e.g., ethyl acetate, propyl acetate, butyl acetate, butyldiglycol acetate, methoxypropyl acetate), ketones (e.g., acetone, methyl ethyl ketone), ethers (e.g., diethyl ether, t-butyl methyl ether, THF), aromatic solvents (toluene, the various regioisomers of xylene, or else mixtures such as solvent naphtha), lactones (e.g., butyrolactone, etc.) or lactams (e.g., N-methylpyrrolidone). Preference is given here to aprotic solvents and solvent mixtures which consist exclusively or else at least in part of aprotic solvents.

The modified particles (P) obtained from the particles (P1) may be isolated by common methods such as, for example, by evaporation to remove the solvents used, or by drying, in a spray dryer or thin-film evaporator, for example, by filtration or by precipitation, as a powder. Additionally, in one preferred procedure, following the preparation of the particles (P), methods of deagglomerating the particles may be used, such as pinned-disk mills or milling/classifying devices, such as pin-disk mills, hammer mills, opposed-jet mills, bead mills, ball mills, impact mills or milling/classifying devices.

A property possessed by the particles (P) is that, following isolation as powders, they can be dispersed in aqueous or organic solvents or else in solvent mixtures. In that case the average diameter of the particles (P) following dispersion, with a maximum size of 200 nm, corresponds to 0.5 to 20 times, preferably 0.5 to 5 times, more preferably 0.5 to 2 times, the average diameter of the particles before isolation as a powder, with the average diameter of the particles (P) before isolation as a powder being determined as the hydrodynamic equivalent diameter in the form of the Z-average by photon correlation spectroscopy.

In this context it was surprising and in no way predictable by the skilled person that the particles (P) which can be prepared using the silane (S), following their preparation, can be isolated as a solid by removal of the solvent, and subsequently exhibit outstanding dispersibility in liquid media, such as aqueous and organic solvents.

If no silane (S) is used in the preparation of the particles (P), or if the silane (S) is used in insufficient amounts, then the particles (P), after isolation as a solid, cannot be redispersed in liquid media, or else the average particle size of the particles (P) exceeds the average diameter of 200 nm prior to isolation and/or after dispersion.

Moreover, the invention is based on the finding that, surprisingly, even partial modification of the solids surface with groups of the general formula [1] produces a negative surface charge of the particles over a wide pH range, and this results, among other things, in a drastic increase in the storage stability of aqueous dispersions of the particles (P), i.e., a reduced tendency toward agglomeration or gelling.

The facility to isolate the particles (P) as a solid, more particularly as a powder, makes it much easier, for example, to produce composite materials comprising the particles (P), as compared with the prior-art processes. Moreover, the negative charge of the particles over a wide pH range is advantageous with regard to the storage stability of aqueous dispersions of the particles (P).

The invention further provides dispersions (D) of the particles (P) and also processes for preparing the dispersions.

In one preferred embodiment of the invention the dispersions (D) are prepared by introducing pulverulent particles (P) into aqueous or organic solvents or else into solvent mixtures and incorporating them by spontaneous wetting or by shaking, as with a tumble mixer, or a high-speed mixer, or by stirring, as by a cross-arm stirrer or dissolver. At low particle concentrations (not more than 10% by weight), simple stirring is generally sufficient for incorporating and dispersing. The dispersing of the pulverulent particles (P) into the liquid is preferably done at a high shear rate. Suitable for this purpose are preferably high-speed stirrers, high-speed dissolvers, for example, with peripheral speeds of 1-50 m/s, high-speed rotor-stator systems, Sonolators, shearing gaps, nozzles, ball mills.

Particularly suitable for dispersing the pulverulent particles (P) is the use of ultrasound in the range from 5 Hz to 500 kHz, preferably 10 kHz to 100 kHz, very preferably 15 kHz to 50 kHz; the ultrasound dispersion may take place continuously or discontinuously. This may take place by means of individual ultrasonic transducers, such as ultrasound tips, or in continuous flow systems, comprising one or more ultrasonic transducers, where appropriate, the systems are separated by a pipeline or pipe wall.

In the preparation of aqueous dispersions (D) from the pulverulent particles (P) it may be advantageous, depending on the nature of the particles (P) employed, to use, preferably, water with different pH values. Dispersion is preferably carried out in a basic medium.

In another embodiment of the invention, dispersions (D) are prepared by reacting the particles (P1) with the silanes (S) in the desired dispersion medium, with the particles (P) being obtainable in an isolation step.

The dispersions (D) preferably contain 1-50% by weight, more preferably 3-30% by weight, very preferably 5-20% by weight of the particles (P).

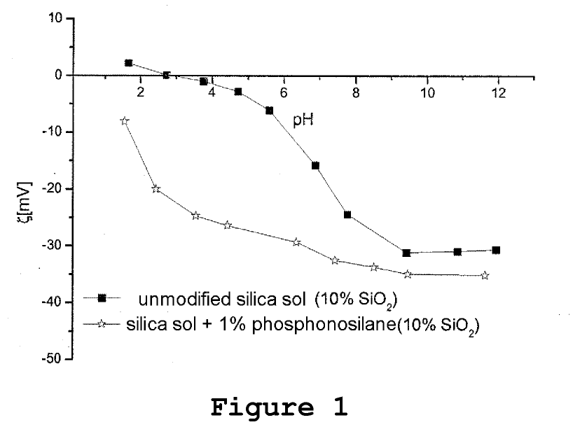

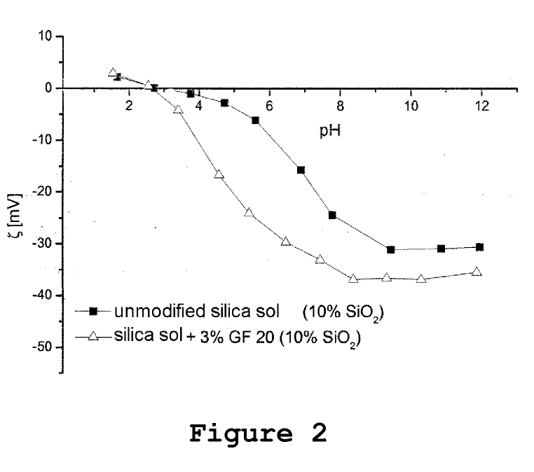

The particles (P) of the invention in the form of the dispersions (D) are further characterized, surprisingly, in that they have a negative ZETA potential over a wide pH range. In general, for the isoelectric point (IEP) of silicas, i.e., the pH at which the ZETA potential has a value of 0, a pH of about 2 is measured, as stated, for example, in M. Kosmulski, J. Colloid Interface Sci. 2002, 253, 77-87. At pH values in the vicinity of the IEP, the amount of the ZETA potential typically becomes very low, i.e., the particles experience only very slight stabilization through the electrostatic repulsion. In contrast, the particles (P) of the invention in aqueous dispersion (D) exhibit, in the vicinity of the IEP, a ZETA potential whose magnitude is significantly greater than that of the corresponding unmodified silica sols (see FIG. 2), or else possess the IEP at a significantly lower pH (see FIG. 1). In both cases the dispersions (D) are significantly more stable than the corresponding unmodified dispersions.

In polar systems, such as solvent-free polymers and resins, or solutions, suspensions, emulsions, and dispersions of organic resins, in aqueous systems or in organic solvents (e.g.: polyesters, vinyl esters, epoxides, polyurethanes, alkyd resins, and others), the pulverulent particles (P) surprisingly exhibit a high thickening effect and are therefore suitable as rheological additives in these systems. As a rheological additive in these systems, the particles (P) deliver the required, necessary viscosity, structural viscosity, and thixotropy, and a yield point which is sufficient for sag resistance on vertical surfaces.

Moreover, in pulverulent systems, the pulverulent particles (P) prevent caking or clumping, under the effect of moisture, for example, but also do not tend toward reagglomeration, and hence to unwanted separation, but instead keep powders fluid and thus permit mixtures which are stable under load and on storage. This is true in particular of their use in nonmagnetic and magnetic toners and developers and charge control agents, as for example in contactless or electrophotographic printing/reproduction processes, which may be 1- and 2-component systems. This is also the case in pulverulent resins which are used as coating systems.

The invention further provides toners, developers, charge control agents, fillers in composite materials, paper coatings, Pickering emulsions, particulate abrasive suspensions for polishing semiconductor components, adsorbents, ion exchangers, which comprise the particles of the invention.

The pulverulent particles (P) of the invention are used in toners, developers, and charge control agents. Such developers and toners are, for example, magnetic 1-component and 2-component toners, but also nonmagnetic toners. As their major constituent these toners may comprise resins, such as styrene resins and acrylic resins, and may preferably have been ground to particle distributions of 1-100 μm, or may be resins which have been prepared in polymerization processes in dispersion or emulsion or solution or in bulk to particle distributions of preferably 1-100 μm. Silicon oxide and metal oxide are preferably used for improving and controlling the power flow behavior, and/or for regulating and controlling the triboelectric charge properties of the toner or developer. Toners and developers of this kind can be used in electro-photographic printing and impression processes, and can also be employed in direct image transfer processes.

With particular preference the pulverulent particles (P) serve as fillers in composite materials, including their use as a flame-retardant component, and in coating materials, preferably scratch-resistant clearcoat or topcoat materials, more particularly in the automotive industry, as OEM and refinish coating materials.

The pulverulent particles (P) and the dispersions (D) are suitable, furthermore, for producing paper coatings, as are used, for example, for high-gloss photographic papers.

The pulverulent particles (P) and the dispersions (D) may be used, further, to produce particle-stabilized emulsions, referred to as Pickering emulsions.

A further possibility for the use of the particles (P) and of the dispersions (D) lies in their application as a particulate abrasive or polishing agent or as formulated polishing agent suspensions which are used in polishing operations, as for example in the production of optical components, of electrooptical components or of semiconductor elements, such as, for example, in the production of processors, logic components or memories, in the operation, for example, of chemical and mechanical polishing and planarization, or else as an adsorbent or ion exchanger.

All of the above symbols in the above formulae have their definitions in each case independently of one another. In all formulae the silicon atom is tetravalent.

Unless indicated otherwise, all amounts and percentages are by weight, all pressures are 0.10 MPa (abs.), and all temperatures are 20° C.

### EXAMPLE 1

### Synthesis of Phosphonate-Functional Particles from an Aqueous Silica Sol

A dilute aqueous silica sol prepared by adding 5.00 g of water to 6.25 g of an aqueous silica sol (LUDOX® AS 40 from GRACE DAVISON, 24 nm, 40% by weight) is admixed dropwise with 0.60 g of an aqueous solution of sodium 3-(trihydroxysilyl)propyl methylphosphonate ((HO)₃Si(CH₂)₃—O—P(O)(CH₃)(ONa), CAS 84962-98-1, Aldrich No. 435716, 42% in water) and the mixture is heated at 60° C. for 5 h. Distillative removal of the solvent gives 2.61 g of a colorless powder which can be dispersed in water by stirring. The average particle size of the silica sol in water (adjusted with dilute ammonia to pH=11), determined as the average hydrodynamic equivalent diameter in the form of the Z-average by means of dynamic light scattering (Zetasizer Nano from MALVERN), was 41 nm.

### EXAMPLE 2

### Synthesis of Carboxylate-Functional Particles from an Organosol

15.0 g of a silica sol in isopropanol (IPA-ST from NISSAN CHEMICAL, 12 nm, 30% by weight) are admixed dropwise with 0.46 g of 3-(triethoxysilyl)propyl-succinic anhydride (Silane GF20, WACKER CHEMIE AG, Munich) and the mixture is heated at 60° C. for 6 h. Distillative removal of the solvent gives 4.98 g of a colorless powder which can be dispersed in dilute ammonia (pH=10) by stirring. The average particle size of the silica sol in dilute ammonia (pH=10), determined as the average hydrodynamic equivalent diameter in the form of the Z-average by means of dynamic light scattering (Zetasizer Nano from MALVERN), was 22 nm.

### EXAMPLE 3

### Preparation of an Aqueous Dispersion of Phosphonate-Functional Particles

100 g of a silica sol prepared by the Stöber process from tetraethoxysilane (14.4% by weight SiO₂, 30 nm, ammonia-stabilized, pH=10) are admixed dropwise with 0.34 g of an aqueous solution of sodium 3-(trihydroxysilyl)propyl methylphosphonate ((HO)₃Si(CH₂)₃—O—P—(O)(CH₃)(ONa), CAS 84962-98-1, Aldrich No. 435716, 42% in water) and the mixture is heated at reflux for 2 h. This gives a silica sol which in acidic, neutral and basic media (pH=2-12) exhibits a higher stability than the corresponding unmodified silica sol. FIG. 1 shows the zeta potential as a function of the pH. The average particle size of the silica sol in water, determined as the average hydrodynamic equivalent diameter in the form of the Z-average by means of dynamic light scattering (Zetasizer Nano from MALVERN), was 30 nm after silane modification. FIG. 1 shows the zeta potential (ζ) as a function of the pH. Titration with 0.5 M KOH or 1.0 M HNO₃ (10% by weight SiO₂; ion background: 0.01 M KCl). In the pH range 2-12 the silane-modified silica sol shows a significantly more negative zeta potential than the unmodified silica sol.

### EXAMPLE 4

### Preparation of an Aqueous Dispersion of Carboxylate-Functional Particles

100 g of a silica sol prepared by the Stöber process from tetraethoxysilane (14.4% by weight SiO₂, 30 nm, ammonia-stabilized, pH=10) are admixed dropwise with 0.43 g of 3-(triethoxysilyl)propylsuccinic anhydride (GF20, WACKER CHEMIE AG, Munich) and the mixture is heated at reflux for 2 h. This gives a silica sol which in acidic, neutral and basic media (pH=3.5-12) exhibits a higher stability than the corresponding unmodified silica sol. FIG. 2 shows the zeta potential as a function of the pH. The average particle size of the silica sol in water, determined as the average hydrodynamic equivalent diameter in the form of the Z-average by means of dynamic light scattering (Zetasizer Nano from MALVERN), was 30 nm after silane modification.

FIG. 2 shows the zeta potential (ζ) as a function of the pH. Titration with 0.5 M KOH or 1.0 M HNO₃ (10% by weight SiO₂; ion background: 0.01 M KCl). In the pH range 3.5-12 the silane-modified silica sol shows a significantly more negative zeta potential than the unmodified silica sol.

1. -12. (canceled)

13. A composition comprising pulverulent particles which have on their surface groups of the formula [1],
—O₁₊ₙ—SiR¹₂₋ₙ—B [1],
where the average diameter of the particles (P) following dispersion in water over a pH range of 1 to 12 is less than or equal to 200 nm and is determined as the average hydrodynamic equivalent diameter in the form of the Z-average by photon correlation spectroscopy,
and where
R¹ is an optionally substituted aliphatic or aromatic hydrocarbon radical having 1-12 carbon atoms,
B is an optionally substituted aliphatic or aromatic hydrocarbon radical comprising at least one organic acid function or salt thereof, and
n is 0, 1 or 2.

14. The composition of claim 13, wherein B contains an optionally substituted hydrocarbon radical which contains at least one carboxylic acid [—C(O)OH], phosphonic acid [—P(O)(OH)(OR²), —O—P(O)(R²)(OR²)] or sulfonic acid [—S(O)₂(OH)] function or salt thereof,
where R² is an optionally substituted aliphatic or aromatic hydrocarbon radical.

15. The composition of claim 13, wherein the particles comprise a colloidal silicon oxide or colloidal metal oxide.

16. The composition of claim 15, wherein the particles comprise a silica sol.

17. The composition of claim 13, wherein the average diameter of the particles (P) in dispersion in a liquid medium, measured as the average hydrodynamic equivalent diameter in the form of the Z-average by photon correlation spectroscopy, is not more than 200 nm.

18. A process for preparing a composition comprising pulverulent particles of claim 13 which on their surface have groups of the formula [1],
—O₁₊ₙ—SiR¹₂₋ₙ—B [1],
in a two-stage process, where
(a) in a first process stage, reacting particle (P1) with at least one silane (S) of the formula [2], [3] or mixture thereof,
X₁₊ₙ—SiR¹₂₋ₙ—B [2],
X₁₊ₙ—SiR¹₂₋ₙ—C [3],
and/or the hydrolysis and condensation products derived therefrom, or with a mixture consisting of the silane (S) and the hydrolysis and condensation products derived therefrom, the group C of the formula [3] being converted, in the course of the preparation of the particles (P), into a group B, and
(b) in a second process stage, isolating the particles (P) as a powder, the average diameter of the particles (P) after dispersion in water in the pH range from 1 to 12, being 200 nm or less, and being from 0.5 to 20 times the average diameter of the particles before isolation as a powder, the average diameter of the particles (P) being determined as the average hydrodynamic equivalent diameter in the form of the Z-average by photon correlation spectroscopy,
where
X is a halogen, hydroxyl, alkoxy, carboxylate, enolate, or siloxy —O—Si≡ group,
R¹ is an optionally substituted aliphatic or aromatic hydrocarbon radical having 1-12 carbon atoms,
B is an optionally substituted aliphatic or aromatic hydrocarbon radical comprising at least one organic acid function or salt thereof,
C is a functional hydrocarbon radical which can be converted by hydrolysis into a group B, and
n is 0, 1 or 2.

19. The process of claim 18, wherein a silane (S) has a structure of the formula [4]-[8], 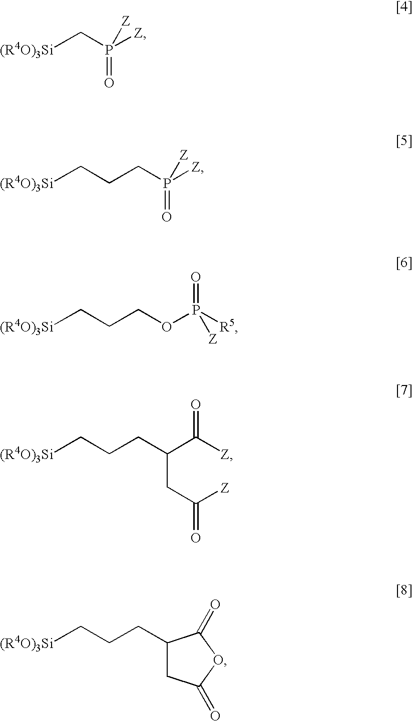
where
R⁴ is hydrogen or an optionally substituted aliphatic or aromatic hydrocarbon having 1-6 carbon atoms,
R⁵ is an optionally substituted aliphatic or aromatic hydrocarbon having 1-6 carbon atoms,
R⁶ is an optionally substituted aliphatic or aromatic hydrocarbon having 1-6 carbon atoms, and
Z is OH, OR⁶, a halogen atom or a radical OW, and
W is a metal cation or an ammonium ion.

20. The process of claim 18, wherein starting particles P1 are colloidal silicon oxide or colloidal metal oxide particles.

21. The process of claim 20, wherein a silica sol is used as a starting particle.

22. A process for preparing a dispersion which comprises a composition of claim 13, wherein the particles (P) are prepared by reacting particles (P1) with silanes (S) in the desired dispersion medium.

23. The composition of claim 13 which comprises a dispersion.

24. In a particle-containing composition selected from the group consisting of toners, developers, charge control agents, fillers in composite materials, paper coatings, Pickering emulsions, particulate abrasive suspensions for polishing semiconductor components, adsorbents, or ion exchangers, the improvement comprising including in the particle-containing composition at least one composition of claim 13.
